(19) United States
(12) Patent Application Publication
(10) Pub. No.: US 2011/0277701 A1
(43) Pub. Date: Nov. 17, 2011

(54) Protective Collar Adapted for Engagement to Animal Neck

(76) Inventor: Margie King, San Diego, CA (US)

(21) Appl. No.: 13/106,840

(22) Filed: May 12, 2011

Related U.S. Application Data
(60) Provisional application No. 61/333,866, filed on May 12, 2010.

(51) Int. Cl. A01K 15/04

(52) U.S. Cl. 119/815

(57) ABSTRACT

An animal collar for prevention of an animal from reaching its mouth behind its ears. The collar has a planar configuration and is conical in its as-used configuration when formed to a cone shape and engaged through a formed aperture around the neck of the animal. The aperture is adjustable for neck size. Sound dampening or suppression to protect the animal from the megaphone sound gathering tendencies of the cone configuration is provided by a fabric interior surrounding the animal's face and projections formed act as an additional sound dampener.

This application claims priority to U.S. Provisional application No. 61/333,866 filed on Apr. 12, 2010, and is included herein in its entirety by reference.

### BACKGROUND OF THE INVENTION

1. Field of the Invention

The invention herein disclosed relates to collars for engagement around the neck of an animal such as a dog. More particularly, it relates to such a collar device adapted for easy engagement behind the head of an animal such as a dog, which is formed of a novel layered construction to provide the animal with a more comfortable fitting collar. Such collars may be employed to prevent contact by the animal's mouth with rearward parts of its body. The collar is especially useful after surgery to allow wounds to heal or to allow topical medications to be applied in a manner that will not later be disturbed by the animal.

2. Prior Art

Background of the Invention

Protective collars have long been used in veterinary medicine to provide a means to prevent contact between an animal's head and other parts of its body rearward of their head. These types of collars are used, for instance, after surgery to prevent an animal from biting or chewing at dressings or areas below its neck. They are frequently employed with animals to also prevent them from pawing or scratching irritated areas of their body where such contact will simply exacerbate the area further.

Modern renditions of such protective collars have been provided the general form of a truncated cone when in the as-used position, mounted upon the animal's neck. When removed from the neck, such collars take on the general shape of a planar arch and so removed are flat, allowing for easy storage.

To position the collar in the as-used position on the animal's neck, the planar arch shaped component is folded to a truncated cone, and retained in place around the animal's neck by means for fastening, such as interlocking tabs, snaps, lacing, staples, hook and loop fabric, clips, and the like. As animals come in all varieties of shapes and sizes with equal variance in neck and head size, the protective collars are generally offered in a variety of sizes or size ranges to accommodate animals of various sizes. When in place in the as-used position on the neck of an animal such as a dog, the inner arch of the planar arch shaped device is secured around the neck of the animal and one end of the planar arch is engaged to the opposite end using the fastening means noted.

Conventionally, such protective collars are formed of a resilient material which will maintain its shape in the as-used position. Such material is conventionally plastic-based sheeting or foam sheeting, which is flexible but resilient enough to maintain a cone shape when fastened to the neck of the animal.

However, such flexible sheeting material, has an edge encircling the animal's neck, in the as-used position, that tends to be sharp and irritating over time. Additionally, the inner surface of the cone, which surrounds the animal's face, when formed of a solid foam or plastic sheet, tends to gather sounds and amplify them which can be unnerving for an already sick or injured animal. Further, this inner surface is hard and uncomfortable for the animal when wearing the device and trying to rest its head in a lying position. Additionally, the cone when formed of a foam or plastic sheet, does not absorb any liquids and over time the animal's face will end up contacting a wet or moist surface when lying down with the collar in the as-used position.

As a consequence, animals who have experienced the discomforts of conventional cone shaped collars and have been spooked or irritated by the amplified sounds communicated to their ears when surrounded by the cone surface, tend to avoid any subsequent engagement of such collars. When wearing such foam or plastic sheet collars, the animals are rendered uncomfortable when trying to lie down since their head is supported by the slick or even wet inner surface of the cone shaped collar when in the as-used position.

Still further, the exterior surface of a foam sheet or plastic sheet conventional cone collar is not attractive. Conventionally, it may be clear or the single color of the plastic or foam sheet. Additionally, if the sheeting is clear or semi transparent, the animal wearing the collar is constantly bothered by shadows of moving objects and people and animals approaching the animal from the side. The lack of color on the exterior tends to discourage use by humans for their animal, and a constant irritant is posed to the animal wearing the collar who perceives the unknown shapes and shadows through the planar material as possible threats, but cannot ascertain what they are since the collar surrounds their head.

As such, there exists an unmet need, for a protective collar for animals which may be worn around the neck to prevent contact with areas of their body rearward of the head, by the mouth of the animal. Such a device should provide a comfortable and dry surface on the side adjacent to the head of the animal. Such a device should be adapted to prevent the cone-shaped collar from becoming an amplifier to common sounds communicated to the animal's ears. Such a collar should also endeavor to shield the animal from sensing visual movement through the surface of the collar to keep the animal calm during use of the collar. Finally, such a collar should be aesthetically pleasing to humans to encourage its use for the dog or other animal in need of it.

The present invention solves the aforementioned shortcomings of the prior art in that it is adapted for an easy engagement around the neck of the animal and provides different material to provide different interior and exterior surfaces adapted to rectify the aforementioned problems.

With respect to the above, before explaining at least one preferred embodiment of the animal collar herein in detail or in general, it is to be understood that the invention is not limited in its application to the details of construction and to the arrangement of the neck mount, or other components or the steps set forth in the following description or illustrated in the drawings. The various apparatus and methods of the disclosed protective collar invention are capable of other embodiments, and of being practiced and carried out in various ways, all of which will be obvious to those skilled in the art, once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for designing other modes of a frusto conic shaped animal collar, and, for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

The disclosed device and method provides a solution to the above noted shortcomings of conventional cone shaped animal collars which are conventionally employed to prevent the animal wearing it from contacting their body with their mouth.

In all modes of the device, the collar is formed of a planar body which is itself formed in a layered configuration to provide different inner, outer, and supportive surfaces which solve the aforementioned problems of conventional cone shaped collars.

Support to maintain the collar in a cone shape when engaged to the neck of the animal, is provided by a resilient planar foam material such as polyethylene foam. On a first side surface of the planar core is engaged a soft and liquid absorbent washable material such as a poly fleece. The poly fleece material provides a soft and comfortable surface for the face of the animal wearing the device in the as-used position and lying down. Further, the poly fleece, or similar soft material, provides a means to dampen incoming sound to the interior of the device when worn in a cone shape in the as-used position. Consequently, rather than amplifying surrounding sounds and irritating an already uncomfortable animal, the fabric on the interior surface dampens or muffles sound, which tends to calm the animal.

The interior surface fabric in a preferred mode of the device, is engaged to the interior surface of the cone when formed to the as-used position, by minimal means of attachment. Rather than adhering the fabric to the interior surface with adhesive over a wide area, instead, the fleece or other fabric is stitched to the interior core material. This stitching method of attachment leaves a plurality of soft fabric panels that are loose from the interior core material and will stretch and better comfort the face of an animal laying down and contacting the inner surface with their face.

The exterior surface of the device is also covered with fabric which adds an ornamental aspect to the device which encourages human guardians of the animal to use it, where they might not use a conventional device which does not appear aesthetically pleasing. The exterior fabric is also engaged to the inner foam or plastic core using stitching. However, it may be glued to the exterior also.

The two layers of fabric combined with the inner core material, serves to block the shadows produced by moving animals and things adjacent to the collar in the as-used position on an animal. This blocking of shadowy moving figures, combined with the noise reduction of the interior fabric, provides a means to maintain the animal user in a calm state over time since they hear much less and cannot see the moving shadowy figures.

It is an object of this invention to provide an improved cone shaped protective collar for animals, which is formed of multiple layers, each of which provides a novel function.

It is another object of this invention to provide such a collar which has a first surface adapted for comfort against the face of an animal wearing it, and which muffles sounds which might excite the animal wearing a conventional cone.

Finally, it is an object of this invention to provide such a protective collar which is aesthetically pleasing to the animal's owner, and which prevents the animal from seeing shadowing figures through the body of the collar.

These together with other objects and advantages which become subsequently apparent reside in the details of the cone shaped protective animal collar herein as more fully hereinafter described and claimed, reference being had to the accompanying drawings forming a part thereof, wherein like numerals refer to like parts throughout.

### BRIEF DESCRIPTION OF DRAWING FIGURE

FIG. 1 depicts the device in a cone shape and in a perspective view showing the interior and exterior surfaces in the as-used position.

FIG. 2 shows another view of the device of FIG. 1 in its planar state and showing the multiple layers forming the device.

FIG. 3 shows a sectional view through FIG. 2 showing the multiple layer construction.

FIG. 3a depicts a particularly preferred mode of the device showing undulating or conical projections of the foam and overlain fabric for sound dampening of the device.

FIG. 4 depicts a plan view of the device showing three sections attached to the interior core using stitching and the hook and loop fabric for forming it to a cone.

FIG. 5 depicts a plan view of the device showing four sections attached to the interior core using stitching and the hook and loop fabric for forming it to a cone.

FIG. 6 depicts the device in the as-used position on an animal with the interior surface adjacent to the face and the aesthetically pleasing exterior fabric and sound dampening interior surface.

FIG. 7 shows an opposite side view from that of FIGS. 4 and 5 and depicts the hook and loop fabric positioned on both sides surface for engagement and adjustment.

### DETAILED DESCRIPTION OF THE PREFERRED EMBODIMENTS OF THE INVENTION

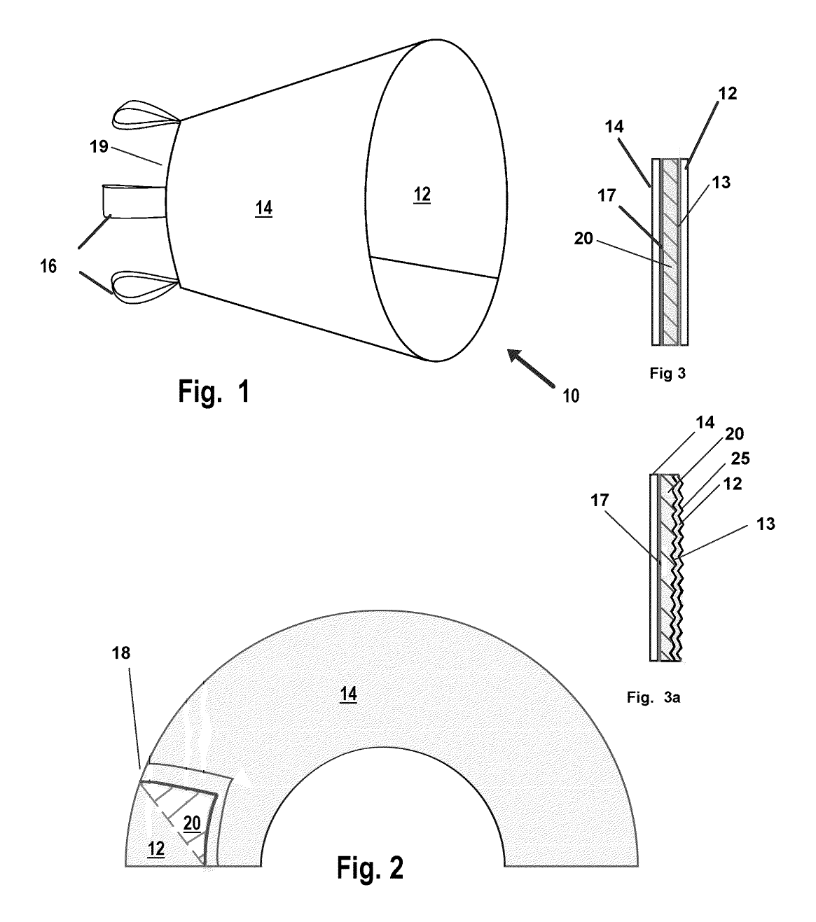

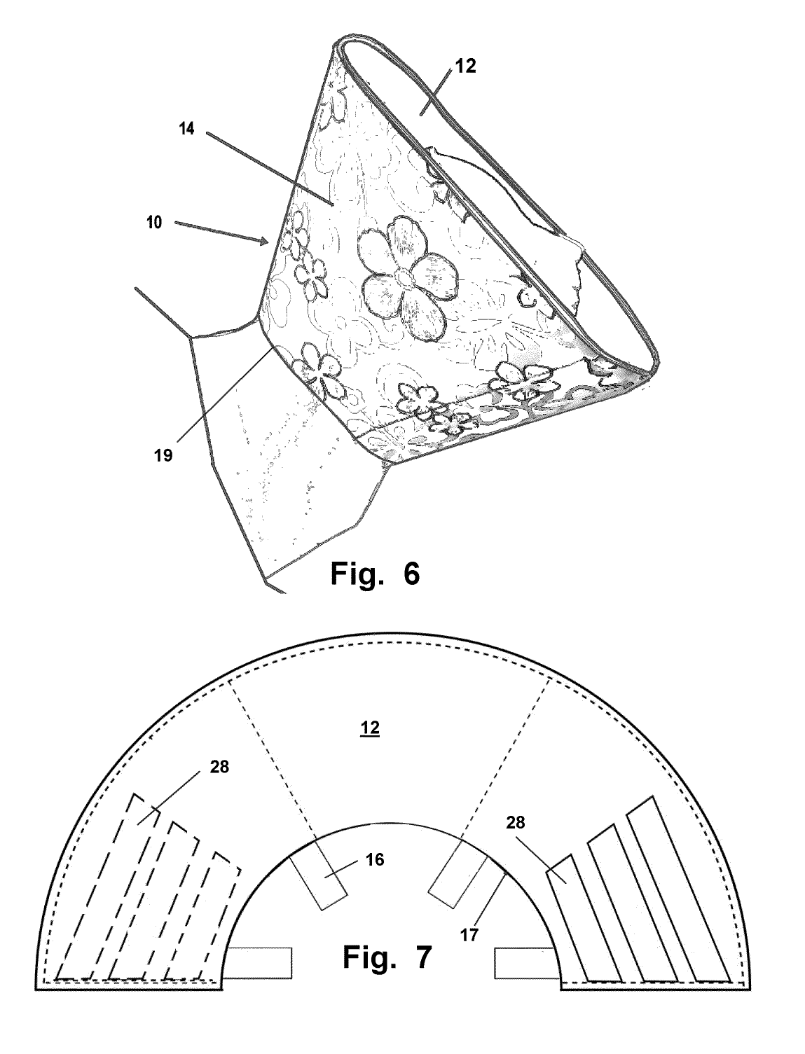

Referring now to the FIGS. 1-7, there is seen in FIG. 1, the perspective view of the device 10 formed from the planar shape of FIG. 2, to a cone shape. In the cone shape, the device 10 employs a foundational core 20 having a first surface 13 which is engages with an interior surface 12 adjacent using one or a combination of sewing and adhesive or other means for engagement as would occur to those skilled in the art, and which is placed next to the face of the animal in the as-used position of FIG. 6. The and second surface 17 of the core 20 is engaged with an exterior surface 14 using the same means of attachment as the interior surface 12 and is viewable from the exterior of the cone shaped device as shown in the as-used position of FIG. 7.

A plurality of collar loops 16 are engaged to the edge of the collar device 10 so they may be engaged on the animal's collar which is routed through the loops 16. The loops may be formed of material adapted to the task, however as a means to prevent injury to the animal should the edge of the device 10 get caught on an obstacle while the animal is running or moving, the loops 16 can be made from elastic material such as rubber, or made to tear away at a force that might injure the animal.

An interior arch 17 edge forms a mounting aperture 19 when the two ends of the device 10 are operationally engaged with hook and loop fabric 28. Translatable positioning of the engagement defines the final size of the formed aperture 19. The aperture is thereby rendered adjustable for neck size of the animal by the aligned hook and loop fabric 28 on opposite sides of the device 10 as seen in FIG. 7.

In FIG. 2, there is shown the device 10 in a planar configuration, and also showing the layers 18 which combine to form the collar device 10. The interior surface 12 is preferably formed of fleece or soft material to provide the animal soft surroundings. The first side 13 of the core 20 is formed of foam, or plastic sheeting, or other flexible material of sufficient stiffness to form the cone when the two ends are engaged with hook and loop fabric. The exterior surface 14 is shown attached to the second surface 17 of the core 20.

In FIG. 3 is shown a sectional view of the device 10 showing the core 20 and the interior surface 12 engaged to the first surface 13 of the core 20, and the exterior surface 14 engaged to the second surface 17 of the core 20.

A particularly preferred mode of the device 10 is shown in FIG. 3a. This mode has been found to significantly enhance the sound dampening ability of the device 10 and eliminating the megaphone characteristics of conventional dog collars which both scare and impair the animal. In FIG. 3a is shown a sectional view of the device 10 showing the core 20 and the interior surface 12 being dimpled or having conical projections. These projections may be formed either by using an interior surface material having them, or forming the first surface 13 of the core 20 with projections and engaging the interior surface 12 thereon to mirror the projection shape. The projections 24 and recesses between them, significantly enhance the sound dampening ability of the device 10 in the as-used position of FIG. 6 and is preferred to protect the animal from loud noises.

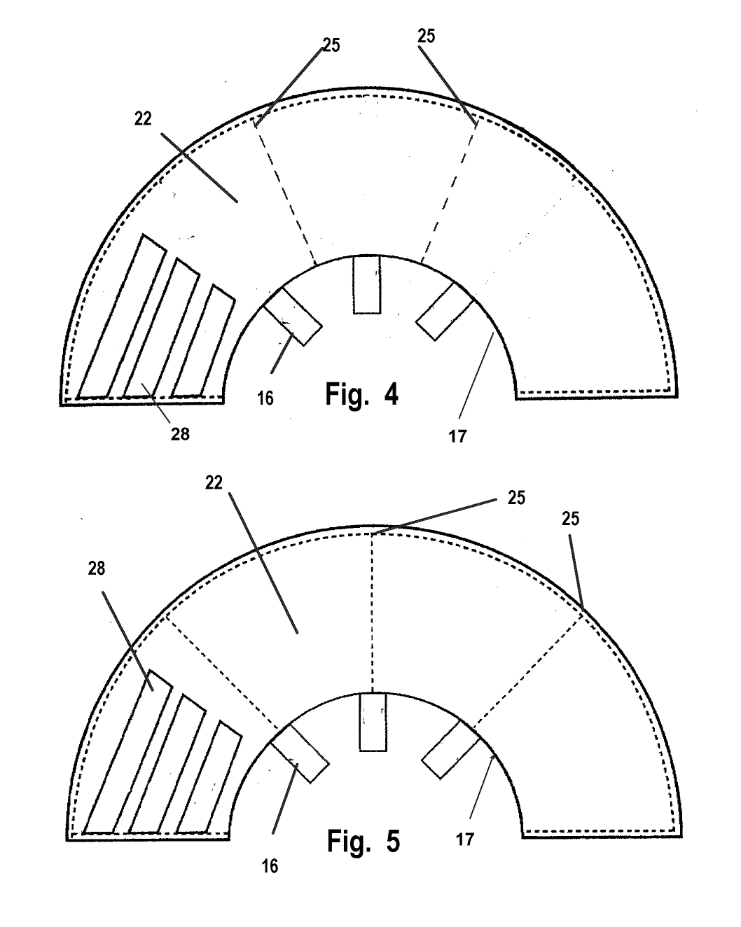

In FIG. 4, the device 10 is shown in one favored configuration wherein a plurality of three panels 22 are formed by the stitching 25 holding the interior and exterior fabric layers to the core 20. Similar in construction is the device of FIG. 5, wherein a plurality of four panels 22 are formed by the stitching 25 engaging the fabrics to the core 20.

The device 10 as depicted in the other figures, is shown in FIG. 6, in an as-used position, wherein the device 10 is engaged around the neck of an animal rearward of the head using the hook and loop fabric 28 to engage and to adjust the size of the aperture 19 by translating the interior surface across the exterior and engaging at the proper aperture 19 size. The exterior surface 14 is covered by aesthetic fabric and the interior surface 12 is covered by a soft fleece type fabric which will aid in sound suppression by itself, and will significantly aid in sound suppression or dampening when engaged over a first surface 13 having projections. The fleece also provides a dry and soft surface to the animal's head. Hook and loop fabric 28 provides the means to maintain the device 10 on the animal's neck and in the conical shape and as noted, adjust the aperture 19.

In FIG. 7, there is shown the device 10 in a planar configuration, from the opposite side of FIGS. 4 and 5 and shows the hook and loop fabric 28 on both sides of the device 10. A plurality of four loops 16 is shown which has been found to best support the device on the collar of a majority of animals and is favored.

While all of the fundamental characteristics and features of the conical animal collar system herein, and employment thereof, have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the disclosed animal collar apparatus as defined by the following claims.

What is claimed is:

1. An animal collar having a planar configuration and conical as-used configuration when engaged to the neck of an animal, comprising:
an arch shaped core having a first surface and a second surface, a first curved edge and a second curved edge;
fabric material engaged to said first surface;
hook and loop fabric positioned at ends of said arch shaped core on opposite sides of said core;
engagement of said hook and loop fabric forming said first curved edge to an aperture for engagement of said collar around a neck of an animal; and
said first surface and said second surface translatably engageable with said hook and loop fabric as a means for adjusting a size of said aperture, whereby said collar may be engaged around an animal's neck which is positioned through said aperture with said fabric material positioned adjacent to a face of said animal as a protection from abrasion and means to dampen sound collected by a conical shape assumed by said device in said as-used position.

2. The animal collar of claim 1 additionally comprising:
projections formed in said fabric material projecting away from said first surface of said core;
depressions between said projections; and
said projections and depressions providing means dampen sound entering an interior surface of said collar in said conical shape from a reflection to the ears of said animal wearing said collar.

3. The animal collar of claim 1 additionally comprising:
a plurality of loops positioned adjacent to said first curved edge providing means of engagement of said collar to an animal collar.

4. The animal collar of claim 2 additionally comprising:
a plurality of loops positioned adjacent to said first curved edge providing means of engagement of said collar to an animal collar.

5. The animal collar of claim 1 additionally comprising:
said plurality of loops positioned adjacent to said first curved edge being elastic and thereby providing means to absorb a shock of an impact of said collar from a transmission to said neck of said animal.

6. The animal collar of claim 2 additionally comprising:
said plurality of loops positioned adjacent to said first curved edge being elastic and thereby providing means to absorb a shock of an impact of said collar from a transmission to said neck of said animal.

7. The animal collar of claim 3 additionally comprising:
said plurality of loops positioned adjacent to said first curved edge being elastic and thereby providing means to absorb a shock of an impact of said collar from a transmission to said neck of said animal.

8. The animal collar of claim 4 additionally comprising:
said plurality of loops positioned adjacent to said first curved edge being elastic and thereby providing means to absorb a shock of an impact of said collar from a transmission to said neck of said animal.

9. The animal collar of claim 1 additionally comprising:
said plurality of loops positioned adjacent to said first curved edge being formed of material configured to tear away at a determined force, thereby providing means to prevent said force impacting said collar from transmission to said neck of said animal.

10. The animal collar of claim 2 additionally comprising:
said plurality of loops positioned adjacent to said first curved edge being formed of material configured to tear away at a determined force, thereby providing means to prevent said force impacting said collar from transmission to said neck of said animal.

11. The animal collar of claim 3 additionally comprising:
said plurality of loops positioned adjacent to said first curved edge being formed of material configured to tear away at a determined force, thereby providing means to prevent said force impacting said collar from transmission to said neck of said animal.

12. The animal collar of claim 4 additionally comprising:
said plurality of loops positioned adjacent to said first curved edge being formed of material configured to tear away at a determined force, thereby providing means to prevent said force impacting said collar from transmission to said neck of said animal.
